(19) United States
(12) Patent Application Publication
(10) Pub. No.: US 2003/0123214 A1
(43) Pub. Date: Jul. 3, 2003

(54) Method for enhancing the flow of electrical charges in micro-geologic structures

(76) Inventors: Walter Stumberger, Hightstown, NJ (US); Sheila Phillips-Stumberger, Hightstown, NJ (US)

Correspondence Address: Walter W. Stumberger, 203 Dutch Neck Road, Hightstown, NJ, 08520, US

(21) Appl. No.: 10/034,799

(22) Filed: Jan. 3, 2002

(51) Int. Cl. H05F 3/02; H05F 3/00; H01H 1/00

(52) U.S. Cl. 361/237; 361/231

(57) ABSTRACT

The system and method of this invention enhances the flow of electrical charges in selected micro-geologic regions by introducing a more conductive material into the geology of the selected region. In one simplistic embodiment, a circle of bare copper wire, bonded so as to create a single electrical entity of the lowest possible electrical resistance, is buried in the soil of the selected area in close physical contact with the soil and other components of the geology.

### BACKGROUND OF THE INVENTION

In electrical terms, the Earth is considered a general and global conductor of electrical charge. Among electrical and electronic engineers, the Earth is considered the final drain for all electrical charges and hence is referenced as the “neutral”, the “ground”, or the “earth”, in all cases of electrical and electronic engineering. Almost every electrical and electronic artifact is connected to the “ground” as a final drain for all electrical charges, or as a zero reference point for measuring the electrical charge in a place or artifact. The Earth, and its micro-geologic structures, are not always homogenous and effective conductors of electrical charges. Scientists such as Franklin, Faraday, Ampere, and others, have shown that even in good electrical conductors, electrical charges can be concentrated in certain regions of the conducting medium.

The micro-geologic structures near the surface of the Earth where we live and build consist of powdered rock of varying granularity, rocks, biological products, minerals, salts, water, and other miscellaneous materials. The electrical conductivity of this geology varies from place to place, even places inches apart. The ability of the Earth to dissipate a concentrated electrical charge is directly proportional to the electrical connectivity of the micro-geologic structures. This is very visible when a concentrated area of electrical charge results in a lightening discharge.

Since many structures and artifacts are connected to the Earth as a neutral conductor, and electrical drain of last resort, these structures and artifacts can be adversely affected by sudden changes of electrical charge in the micro-geologic regions that surround them.

This invention creates a more conductive, and more predictive, path for the flow of electrical charges in micro-geologic regions.

### BRIEF SUMMARY OF THE INVENTION

This invention provides an enhanced path for electrical charges by using a more conductive material placed around a selected geological region of less conductive ability.

### BRIEF DESCRIPTION OF THE DRAWINGS

FIG. 1 is a conceptual diagram of the invention. Item 1 is conductive material forming a perimeter of the selected micro-geologic region, indicated as item 2. Item 3 indicates the level of the surface of the Earth and is shown here as a point of reference. Item 4 depicts a possible artifact, such as a building, that could be partially buried in the selected micro-geologic region.

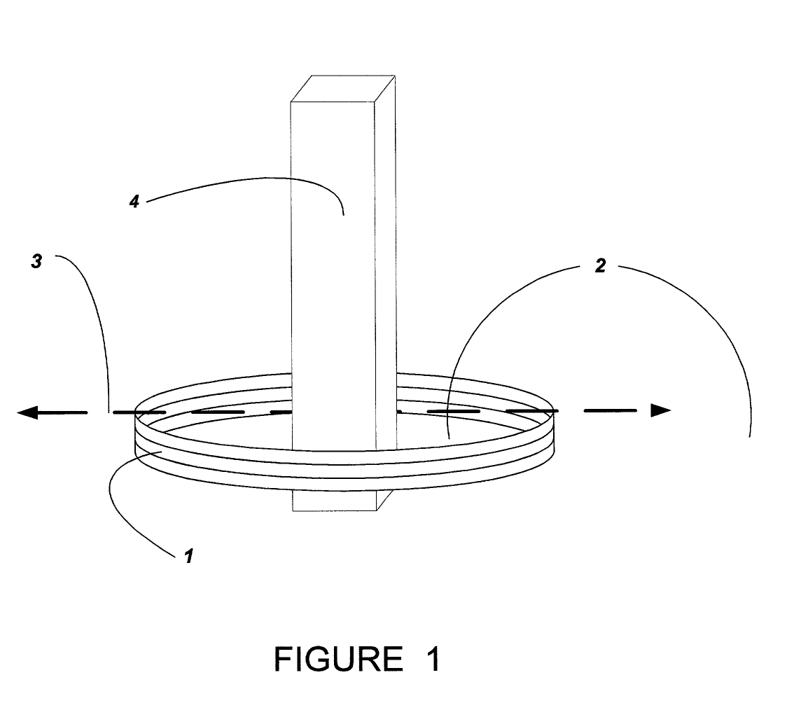

FIG. 2 is an electrical schematic of the invention. The invention uses a conductive material in close physical contact with the surrounding micro-geologic region and is grounded (electrical term) by physical contact with the local geology in one place or in a plurality of places.

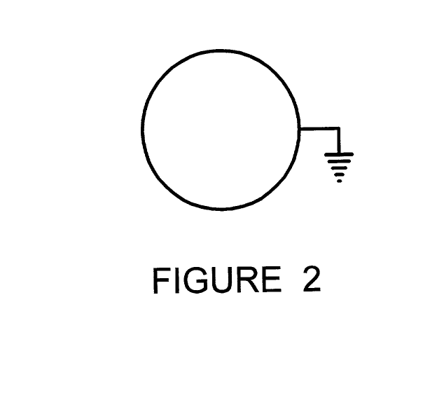

1.) We claim that this invention will provide enhanced conductivity for electrical charges in micro-geologic regions of less electrical charge conductive ability, by
(a) using a more conductive material or plurality of more conductive materials to surround selected micro-geological regions,
(b) with said conductive material or plurality of more conductive materials configured in any geometry in any physical plane, and
(c) with said more conductive material or plurality of more conductive materials connected to themselves or to each other, in the case of plurality of more conductive materials, so as to create a single electrical entity, and
(d) with said electrical entity having physical contact with the microgeologic region in one location or a plurality of locations.

2.) We claim that this invention will enhance the flow of electrical charges in micro-geologic regions of less electrical charge conductive ability, by
(a) providing a more conductive path for the flow of electrical charge through the use of more conductive material,
(b) with said conductive material configured according to selected geometry to electrically encompass selected micro-geologic regions, and
(c) providing a singular point or a plurality of points of electrical contact with the micro-geologic region.

3.) We claim that this invention will provide a more predictive and more conductive path for electrical charges in areas of less natural electrical conductivity by
(a) introducing a more conductive material into a selected region of less conductive geology
(b) with said conductive material configured to provide a conductive perimeter around a selected micro-geologic region, and
(c) having a singular point of contact with the less conductive micro-geology or a plurality of points of electrical contact with less conductive micro-geology.
